(19) United States
(12) Patent Application Publication
(10) Pub. No.: US 2016/0041854 A1
(43) Pub. Date: Feb. 11, 2016

(54) METHOD AND APPARATUS FOR INFORMING CONNECTION CONDITION BETWEEN EXTERNAL DEVICE AND ROUTER

(71) Applicant: Xiaomi Inc., Beijing (CN)

(72) Inventors: Tiejun LIU, Beijing (CN); Liang Cheng, Beijing (CN); Zheng Li, Beijing (CN)

(73) Assignee: Xiaomi Inc.

(21) Appl. No.: 14/715,887

(22) Filed: May 19, 2015

Related U.S. Application Data
(63) Continuation of application No. PCT/CN2015/072032, filed on Jan. 30, 2015.

(30) Foreign Application Priority Data
Aug. 8, 2014 (CN) 201410389817.2

(51) Int. Cl. G06F 9/54; G06F 11/32; G06F 11/30

(52) U.S. Cl. CPC G06F 9/542; G06F 11/3065; G06F 11/324

(57) ABSTRACT

A method for informing a connection condition between an external device and a router, includes: monitoring whether a predetermined event occurs, the predetermined event being one of connecting the external device to the router or disconnecting the external device from the router; determining a registered port of a plugin of the router from one or more ports of a plugin center, if the predetermined event occurs; and sending to the plugin, through the registered port of the plugin, a first notification to indicate that the predetermined event occurs.

### CROSS-REFERENCE TO RELATED APPLICATIONS

This application is a continuation of International Application No. PCT/CN2015/072032, filed Jan. 30, 2015, which is based upon and claims priority to Chinese Patent Application No. 201410389817.2, filed Aug. 8, 2014, the entire contents of all of which are incorporated herein by reference.

### TECHNICAL FIELD

The present disclosure generally relates to router technologies and, more particularly, to a method and an apparatus for informing a connection condition between an external device and a router.

### BACKGROUND

In related art, a router developer adds a function of a plugin platform in a router, and a third-party developer can develop a plugin according to documentation and a software development kit (SDK) provided by the router developer. The developed plugin can run on the plugin platform.

However, when an external device is connected to the router (e.g., plugging the external device into the router), or when the external device is disconnected from the router (e.g., unplugging the external device from the router), the router may not inform the plugin of the connection condition between the external device and the router, and the plugin may not obtain the connection condition between the external device and the router, which degrades performance of the plugin.

### SUMMARY

According to a first aspect of the present disclosure, there is provided a method for informing a connection condition between an external device and a router, comprising: monitoring whether a predetermined event occurs, the predetermined event being one of connecting the external device to the router or disconnecting the external device from the router; determining a registered port of a plugin of the router from one or more ports of a plugin center, if the predetermined event occurs; and sending to the plugin, through the registered port of the plugin, a first notification to indicate that the predetermined event occurs.

According to a second aspect of the present disclosure, there is provided an apparatus for informing a connection condition between an external device and a router, comprising: a processor; and a memory configured to store instructions executable by the processor; wherein the processor is configured to: monitor whether a predetermined event occurs, the predetermined event being one of connecting the external device to the router or disconnecting the external device from the router; determine a registered port of a plugin of the router from one or more ports of a plugin center, if the predetermined event occurs; and send to the plugin, through the registered port of the plugin, a first notification to indicate that the predetermined event occurs.

According to a third aspect of the present disclosure, there is provided a non-transitory computer-readable storage medium having stored therein instructions that, when executed by a processor of an apparatus, cause the apparatus to perform a method for informing a connection condition between an external device and a router, the method comprising: monitoring whether a predetermined event occurs, the predetermined event being one of connecting the external device to the router or disconnecting the external device from the router; determining a registered port of a plugin of the router from one or more ports of a plugin center, if the predetermined event occurs; and sending to the plugin, through the registered port of the plugin, a first notification to indicate that the predetermined event occurs.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for informing a connection condition between an external device and a router, according to an exemplary embodiment.

FIG. 2 is a flow chart of a method for informing a connection condition between an external device and a router, according to an exemplary embodiment.

FIG. 3 is a block diagram of an apparatus for informing a connection condition between an external device and a router, according to an exemplary embodiment.

FIG. 4 is a block diagram of an apparatus for informing a connection condition between an external device and a router, according to an exemplary embodiment.

FIG. 5 is a block diagram of an informing module, according to an exemplary embodiment.

FIG. 6 is a block diagram of an apparatus for informing a connection condition between an external device and a router, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

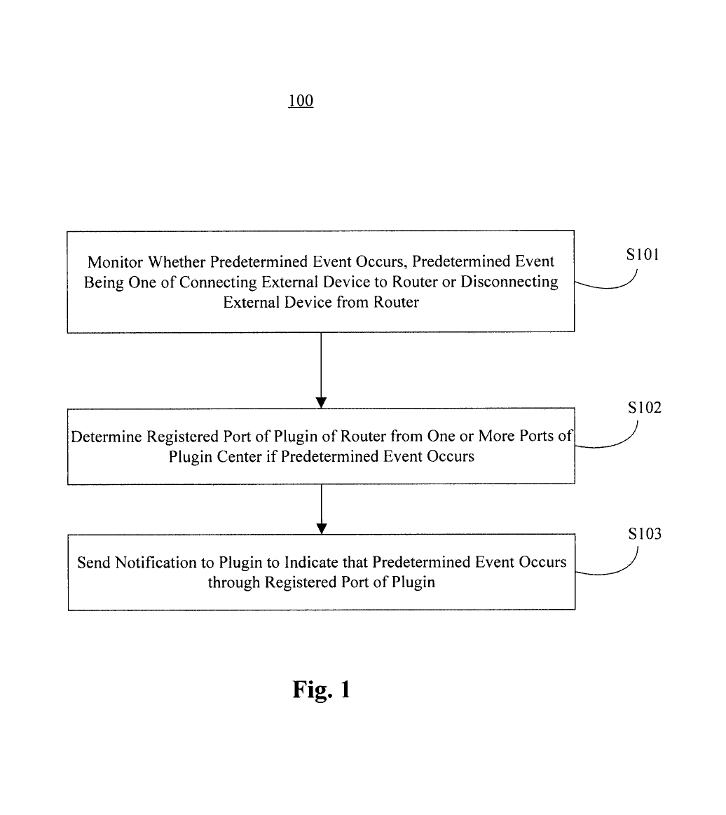

FIG. 1 is a flow chart of a method 100 for informing a connection condition between an external device and a router, according to an exemplary embodiment. For example, the method 100 may be used in the router, such as used in a plugin center of the router. Also for example, the plugin center can be implemented by hardware (e.g., a processor), or software (e.g., a background program started by the router), or a combination of hardware and software. Referring to FIG. 1, the method 100 includes the following steps

In step S101, it is monitored whether a predetermined event occurs, the predetermined event being, e.g., connecting the external device to the router (e.g., plugging the external device into the router), or disconnecting the external device from the router (e.g., unplugging the external device from the router).

In one exemplary embodiment, step S101 is implemented by monitoring whether a notification indicating that the predetermined event occurs is received by the plugin center of the router. For example, a monitoring device in the router monitors whether the predetermined event occurs and, if the predetermined event occurs, the monitoring device sends the notification to the plugin center.

In exemplary embodiments, an external interface is provided on the router and is configured to connect the external device. The external interface may be a wired interface or a wireless interface. In other words, the external device may be connected with the router via a wired connection or a wireless connection. If the external device is connected to the external interface, or if the external device is disconnected from the external interface, the external interface sends the notification to the plugin center of the router.

In step S102, a registered port of a plugin of the router is determined from one or more ports of the plugin center, if the predetermined event occurs.

In one exemplary embodiment, step S102 is implemented by determining the registered port of the plugin center from one or more ports of the plugin center according to a pre-stored one-to-one correspondence between the port of the plugin center and the plugin of the router. For example, the one-to-one correspondence may be stored in a configuration file.

The configuration file can declare a function of the plugin in addition to recording the one-to-one correspondence. Also for example, the plugin center stores the configuration file, which is recorded in a format of key-value type and includes, e.g., three parameters: appid, port, and capability. The appid parameter represents an ID of the plugin, the port parameter represents a registered port number of the plugin, and the capability parameter represents capability of the plugin. For example, a configuration file includes following content:

appid=2919291939, port=10001, capability=USBDISK.

The above content represents that: the ID of the plugin is 2919291939, the registered port number of the plugin center is 10001, and the plugin knows whether a USB device is connected to the router or is disconnected from the router.

In step S103, a notification indicating that the predetermined event occurs is sent to the plugin through the registered port of the plugin.

In one exemplary embodiment, step S103 may be implemented as follows. A Thrift server of the plugin is started, the plugin center is connected with the Thrift server through a socket communication, and the Thrift server of the plugin sends the notification to the plugin through the registered port of the plugin. As one of ordinary skill in the art will understand, Thrift is an interface definition language and communication protocol to define and create services for programming languages.

With the method 100, if a predetermined event, such as connecting the external device to the router or disconnecting the external device from the router, occurs, the plugin center informs the plugin of the router of the occurrence of the event, such that the plugin of the router can obtain the connection condition between the external device and the router and fully function by utilizing the external device, thus improving user experience of the plugin.

In exemplary embodiments, the method 100 further includes establishing the one-to-one correspondence and storing the one-to-one correspondence by the plug center, which can be implemented by the following steps A1-A3.

In step A1, a port registration request sent from the plugin is obtained.

In step A2, a free port is identified in the ports of the plugin center and registered for the plugin, and the one-to-one correspondence between the registered port of the plugin and the plugin is established.

In step A3, the one-to-one correspondence is stored.

In one exemplary embodiment, steps A1-A3 may further be implemented as follows. First, a request of calling an interface of a predetermined program sent from the plugin is obtained. Next, the predetermined program is started to search for the free port in the ports of the plugin center, to register the free port for the plugin and to establish the one-to-one correspondence between the registered port of the plugin and the plugin. Then, the one-to-one correspondence sent from the predetermined program is obtained and stored. For example, the predetermined program may be a software development kit (SDK) or an application program of other types.

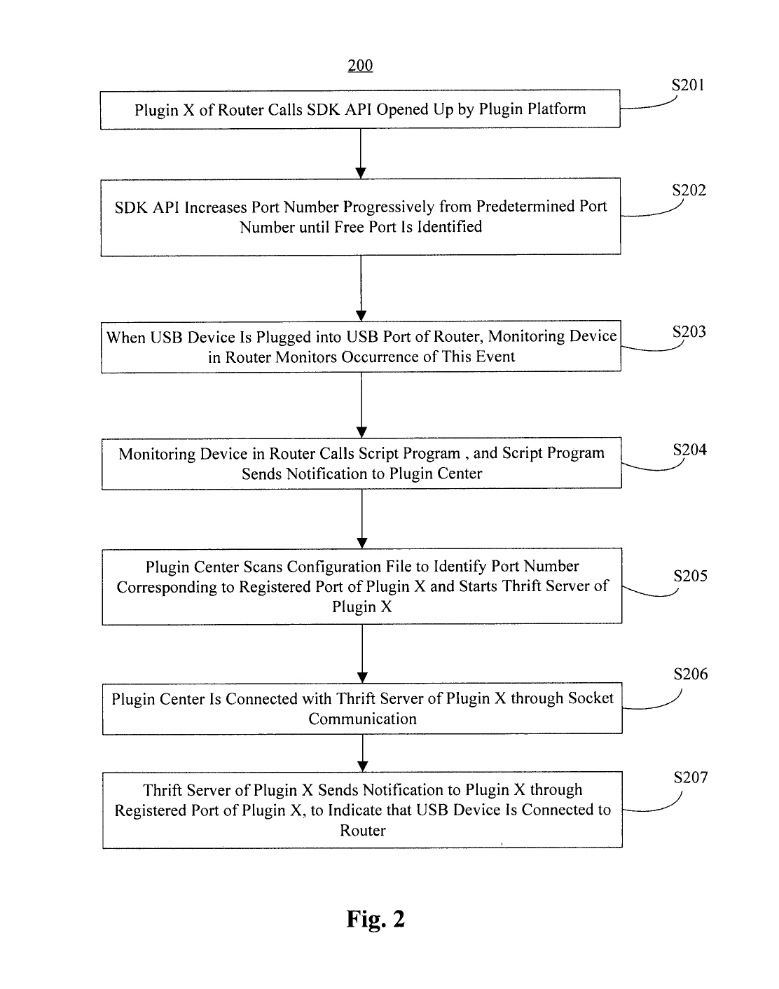

FIG. 2 is a flow chart of a method 200 for informing a connection condition between an external device and a router, according to an exemplary embodiment. For example, the external device may be a USB device, and the router starts a plugin center after the router is started. Also for example, the plugin center is implemented by hardware (e.g., a processor), or software (e.g., a background program started by the router), or a combination of hardware and software. Referring to FIG. 2, the method 200 includes the following steps.

In step S201, a plugin X of the router calls an SDK application program interface (API) opened up by a plugin platform.

In step S202, the SDK API increases a port number progressively from a predetermined port number (such as 10000) in the plugin center, and determines whether a port corresponding to the increased port number is free. If it is determined that the port corresponding to the increased port number is occupied, the SDK API continues increasing the port number until a free port is identified. Then, the SDK API registers the free port for the plugin X and records the port number corresponding to the registered port of the plugin X, an ID of the plugin X, and capability of the plugin X in a configuration file stored in the plugin center (e.g., recording appid=2919291939, port=10001, capability=USBDISK in the configuration file).

In step S203, when the USB device is plugged into a USB port of the router, a monitoring device in the router monitors an occurrence of this event.

In step S204, the monitoring device in the router calls a script program, and the script program sends a notification to the plugin center, to indicate that the USB device is connected to the router.

In step S205, after receiving the notification, the plugin center scans the configuration file to identify the port number corresponding to the registered port of the plugin X and starts a Thrift server of the plugin X.

In step S206, the plugin center is connected with the Thrift server of the plugin X through a socket communication.

In step S207, the Thrift server of the plugin X sends a notification to the plugin X through the registered port of the plugin X, to indicate that the USB device is connected to the router.

In the above embodiment, when an event such as connecting the USB device to the router or disconnecting the USB device from the router occurs, the plugin center of the router informs the plugin of the router of the occurrence of the event, such that the plugin of the router can obtain the connection condition between the USB device and the router and fully function by utilizing the USB device, thus improving user experience of the plugin.

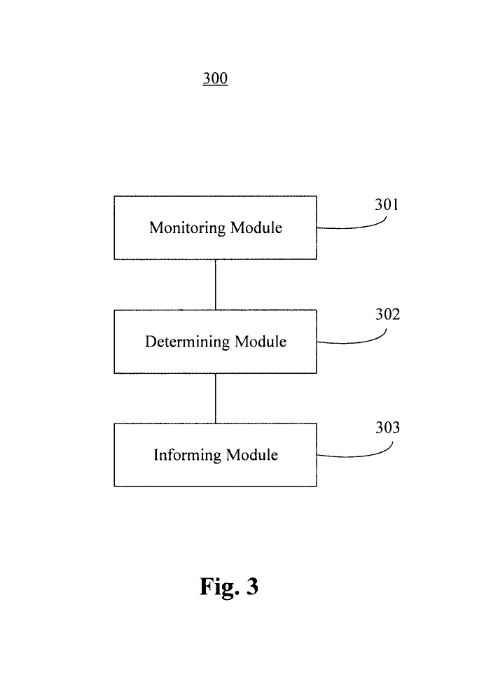

FIG. 3 is a block diagram of an apparatus 300 for informing a connection condition between an external device and a router, according to an exemplary embodiment. For example, the apparatus 300 may be used in a router or a plugin center of the router. Referring to FIG. 3, the apparatus 300 includes a monitoring module 301, a determining module 302, and an informing module 303.

The monitoring module 301 is configured to monitor whether a predetermined event occurs, the predetermined event being, e.g., connecting the external device to the router, or disconnecting the external device from the router. The determining module 302 is configured to determine a registered port of a plugin of the router from one or more ports of the plugin center if the monitoring module monitors that the predetermined event occurs. The informing module 303 is configured to send through the registered port of the plugin determined by the determining module 302 a first notification to the plugin, to indicate that the predetermined event occurs.

In one exemplary embodiment, the monitoring module 301 includes a monitoring unit configured to monitor whether a second notification is received, the second notification indicating that the predetermined event occurs.

In one exemplary embodiment, the determining module 301 includes a determining unit configured to determine the registered port of the plugin from the ports of the plugin center according to a pre-stored one-to-one correspondence between the port of the plugin center and the plugin of the router, if the monitoring module 301 monitors that the predetermined event occurs.

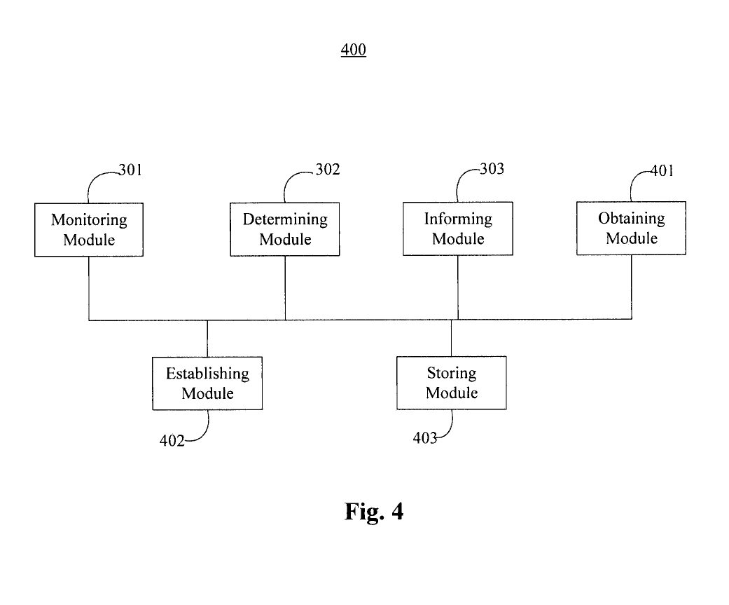

FIG. 4 is a block diagram of an apparatus 400 for informing a connection condition between an external device and a router, according to an exemplary embodiment. Referring to FIG. 4, the apparatus 400 further includes an obtaining module 401, an establishing module 402, and a storing module 403, in addition to the monitoring module 301, the determining module 302, and the informing module 303 (FIG. 3).

The obtaining module 401 is configured to obtain a port registration request from the plugin. The establishing module 402 is configured to identify a free port in the ports of the plugin center, to register the free port for the plugin and to establish the one-to-one correspondence between the registered port of the plugin and the plugin. The storing module 403 is configured to store the one-to-one correspondence.

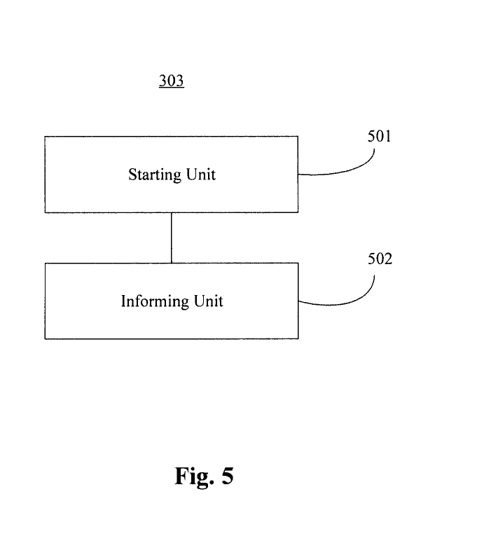

FIG. 5 is a block diagram of the informing module 303 (FIG. 3), according to an exemplary embodiment. Referring to FIG. 5, the informing module 303 includes a starting unit 501 configured to start a Thrift server of the plugin, and an informing unit 502 configured to connect with the Thrift server through a socket communication, wherein the Thrift server is configured to send the first notification to the plugin through the registered port of the plugin.

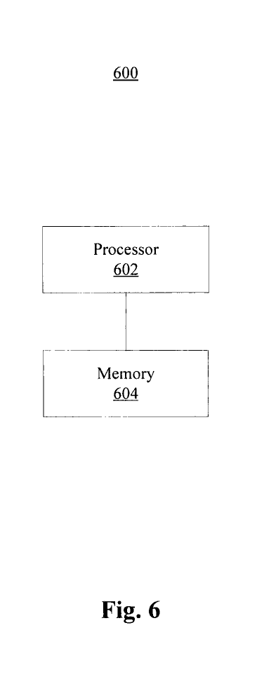

FIG. 6 is a block diagram of an apparatus 600 for informing a connection condition between an external device and a router, according to an exemplary embodiment. For example, the apparatus 600 may be a part of the router, such as a plugin center in the router, or the whole router. Referring to FIG. 6, the apparatus 600 includes a processor 602 and a memory 604 configured to store instructions executable by the processor 602.

The processor 602 is configured to monitor whether a predetermined event occurs, the predetermined event being, e.g., connecting the external device to the router, or disconnecting the external device from the router; determine a registered port of a plugin of the router from one or more ports of the plugin center, if the predetermined event occurs; and send through the registered port of the plugin a first notification to the plugin, to indicate that the predetermined event occurs.

The processor 602 is further configured to monitor whether a second notification is received, the second notification indicating that the predetermined event occurs.

The processor 602 is further configured to determine the registered port of the plugin from the ports of the plugin center according to a pre-stored one-to-one correspondence between the port of the plugin center and the plugin of the router, when the predetermined event occurs.

The processor 602 is further configured to obtain a port registration request from the plugin; identify a free port in the ports of the plugin center, register the free port for the plugin and establish the one-to-one correspondence between the registered port of the plugin and the plugin; and store the one-to-one correspondence in the memory 604.

The processor 602 is further configured to start a Thrift server of the plugin; and connect with the Thrift server through a socket communication, wherein the Thrift server is configured to send the first notification to the plugin through the registered port of the plugin.

In exemplary embodiments, there is also provided a non-transitory computer-readable storage medium including instructions, as included in the memory 604 of the apparatus 600, executable by the processor 602 of the apparatus 600, for performing the above-described methods. For example, the non-transitory computer-readable storage medium may be a ROM, a RAM, a CD-ROM, a magnetic tape, a floppy disc, an optical data storage device, and the like.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for informing a connection condition between an external device and a router, comprising:
monitoring whether a predetermined event occurs, the predetermined event being one of connecting the external device to the router or disconnecting the external device from the router;
determining a registered port of a plugin of the router from one or more ports of a plugin center, if the predetermined event occurs; and
sending to the plugin, through the registered port of the plugin, a first notification to indicate that the predetermined event occurs.

2. The method according to claim 1, wherein the monitoring comprises:
monitoring whether a second notification is received from an external interface, wherein the second notification is configured to indicate that the predetermined event occurs, and the external interface is provided on the router and is configured to connect the external device.

3. The method according to claim 1, wherein the determining comprises:
determining the registered port of the plugin from the one or more ports of the plugin center according to a pre-stored one-to-one correspondence between the registered port and the plugin of the router, if the predetermined event occurs.

4. The method according to claim 3, further comprising:
obtaining a port registration request from the plugin;
identifying a free port in the one or more ports of the plugin center, to register the free port for the plugin and establish the one-to-one correspondence between the registered port of the plugin and the plugin; and
storing the one-to-one correspondence.

5. The method according to claim 1, wherein the sending comprises:
starting a Thrift server of the plugin; and
connecting with the Thrift server through a socket communication, for the Thrift server to send the first notification to the plugin through the registered port of the plugin.

6. An apparatus for informing a connection condition between an external device and a router, comprising:
a processor; and
a memory configured to store instructions executable by the processor;
wherein the processor is configured to:
monitor whether a predetermined event occurs, the predetermined event being one of connecting the external device to the router or disconnecting the external device from the router;
determine a registered port of a plugin of the router from one or more ports of a plugin center, if the predetermined event occurs; and
send to the plugin, through the registered port of the plugin, a first notification to indicate that the predetermined event occurs.

7. The apparatus according to claim 6, wherein the processor is further configured to:
monitor whether a second notification is received from an external interface, wherein the second notification is configured to indicate that the predetermined event occurs, and the external interface is provided on the router and is configured to connect the external device.

8. The apparatus according to claim 6, wherein the processor is further configured to:
determine the registered port of the plugin from the one or more ports of the plugin center according to a pre-stored one-to-one correspondence between the registered port and the plugin of the router, if the predetermined event occurs.

9. The apparatus according to claim 8, wherein the processor is further configured to:
obtain a port registration request from the plugin;
identify a free port in the one or more ports of the plugin center, to register the free port for the plugin and establish the one-to-one correspondence between the registered port of the plugin and the plugin; and
store the one-to-one correspondence.

10. The apparatus according to claim 6, wherein the processor is further configured to:
start a Thrift server of the plugin; and
connect with the Thrift server through a socket communication, for the Thrift server to send the first notification to the plugin through the registered port of the plugin.

11. A non-transitory computer-readable storage medium having stored therein instructions that, when executed by a processor of an apparatus, cause the apparatus to perform a method for informing a connection condition between an external device and a router, the method comprising:
monitoring whether a predetermined event occurs, the predetermined event being one of connecting the external device to the router or disconnecting the external device from the router;
determining a registered port of a plugin of the router from one or more ports of a plugin center, if the predetermined event occurs; and
sending to the plugin, through the registered port of the plugin, a first notification to indicate that the predetermined event occurs.
